(19) United States
(12) Patent Application Publication
(10) Pub. No.: US 2009/0013833 A1
(43) Pub. Date: Jan. 15, 2009

(54) Hex extension with bolster

(76) Inventor: David M. Salanda, Burlington, WI (US)

Correspondence Address: RYAN KROMHOLZ & MANION, S.C., POST OFFICE BOX 26618, MILWAUKEE, WI, 53226, US

(21) Appl. No.: 11/827,682

(22) Filed: Jul. 13, 2007

(51) Int. Cl. B25G 1/04

(52) U.S. Cl. 81/177.2

(57) ABSTRACT

An extension member for use with a socket wrench having a first end portion, a shaft portion connected to the first end portion, and a second end portion connected to the shaft portion opposite of the first end portion. The second end portion has a bore for receiving said socket wrench and an exterior surface shaped to matingly receive a second wrench that can provide alternate torque delivery. The extension member further has at least one bolster located on the second end portion of the extension member.

### BACKGROUND OF THE INVENTION

The present invention relates to sockets, extensions, and adaptors for socket wrenches and ratcheting wrenches. More particularly, the present invention relates to extensions that can an incorporate an external wrench, such as an open end wrench, box wrench, or an adjustable wrench, for extra or alternative torque delivery.

Prior art extensions are designed to have a female end mounted on the drive end of the wrench. The outside of the female end of the extension is cylindrical in shape. However, in many situations, space is an issue and it is not always possible to get an extension or a socket into an area along with the socket wrench, which prevents using the extension in tight areas.

Extensions have been designed to address such situations. For example, Pearce (U.S. Pat. No. 5,438,894), discloses a socket wrench extension in which a first end portion of the wrench has a hexagonal outside perimeter and a square inner perimeter. The hexagonal outside perimeter allows for a second wrench to provide extra torque to the extension. The extension further provides a lip near the hexagonal outside diameter to prevent a wrench from slipping down over the shank of the socket wrench when an external wrench is being used. Another example, Lewis (U.S. Pat. No. 5,568,757), also provides a socket wrench adapter having a hexagonal end having a square inner diameter. The adapter also has a lip that allows for a wrench to rest against.

While these extensions provide advantages over the prior art, there are still possible improvements. For example, the area that receives an external wrench to deliver extra torque may not always be the easiest to grab with a wrench, especially in tight situations, or when the user has to reach above his head to reach the extension member. Thus, it would be advantageous to provide an improved extension member that would assist in the user grabbing the extension member with an external or second wrench, with the wrench being adaptable to be grabbed in alternate placements and locations.

### SUMMARY OF THE INVENTION

The present invention is for an extension member for use with a wrench having a first end portion, a shaft portion connected to the first end portion, and a second end portion connected to the shaft portion opposite of the first end portion. The second end portion has a bore for receiving a socket wrench and an exterior surface shaped to matingly receive a second wrench that can provide alternate torque delivery. The extension member further has at least one bolster located on the second end portion of the extension member.

The bolsters are designed to provide an extra structure for the second end portion that will assist in aligning a second wrench on the second end portion. The bolsters are preferably removable from the extension member, which allows adaptability for the second wrench in that the bolster can potentially be moved or rearranged, depending on the angle for which the extension member is being used.

### BRIEF DESCRIPTION OF THE DRAWINGS

FIG. 1 is a perspective view of a socket wrench extension according to the present invention, with a bolster located on the extension.

FIG. 2 is a perspective view of a second embodiment of a socket wrench extension according to the present invention, having a pair of bolsters located on the extension.

FIG. 3 is a second perspective view of the embodiment of FIG. 2, with the bolsters shown in FIG. 2 being removed from the extension.

FIG. 4 depicts various bolsters used in combination with a socket wrench extension according to the present invention.

FIG. 5 is a further embodiment of a socket extension according to the present invention.

FIG. 6 shows the extension member of FIG. 5 having an alternate bolster arrangement.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

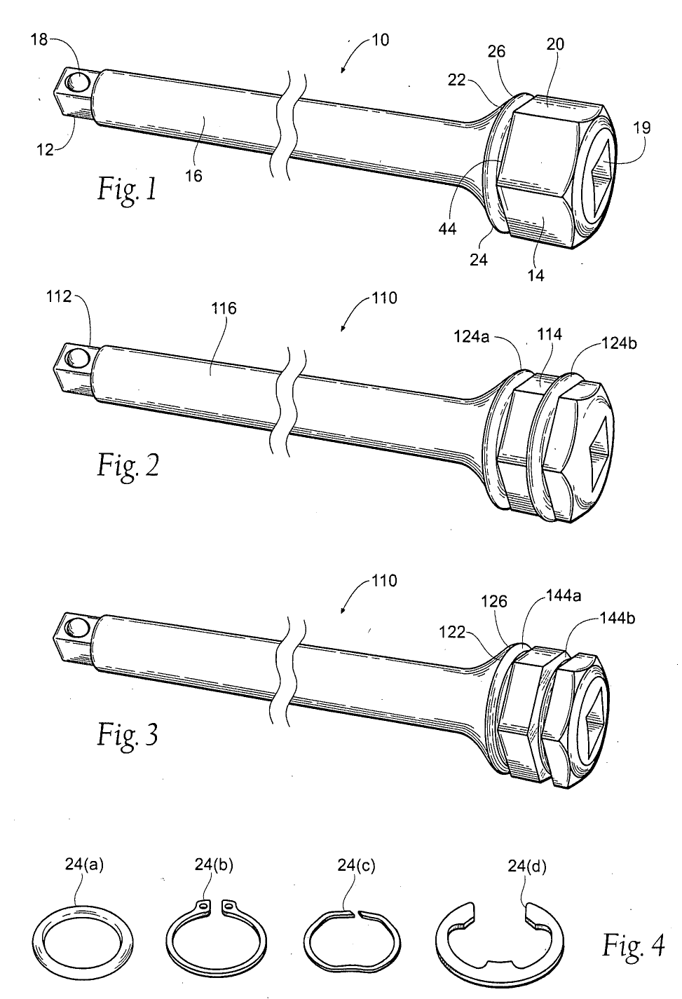

FIG. 1 shows a perspective view of an extension member 10 according to the present invention. The extension member 10 generally comprises a first end portion 12, a second end portion 14, and a shaft or extension portion 16 located between the first end portion 12 and the second end portion 14. The first end portion 12 is shown as being square and including a detent 18 provided thereon the first end portion 12 for retaining a socket (not shown). Other polygonal shapes are possible at the first end portion 12, but the customary shape is a square. The customary detent or ball retention is a small ball with a hidden spring compressed against it. Such detent devices are quite common, though other means of providing releasable attachment of a socket into a socket wrench may be used.

The second end portion 14 comprises a square bore 19, so that the extension member 10 can be attached to a standard socket wrench, ratchet, or other torque delivering device (not shown) to be attached to the extension member 10. The second end portion 14 has a perimeter 20, preferably hexagonal in shape, which allows a secondary device to provide additional torque to the extension member 10. That is, the outer surface of the second end portion 14 is configured so that it can receive a second or alternate wrench, such as an open ended wrench, a box end wrench, an adjustable wrench, or other similar wrench. This is advantageous in situations or arrangements where the use of the extension member 10 does not permit attachment to a socket wrench. For instance, often when working on and around the engine block of a vehicle, it is not possible to actually attach a socket wrench to the extension member, as there may not be enough space or length to attach the socket wrench. An example of a situation where the present invention is particularly useful is the attachment and removal of spark plugs. Current engines are designed to minimize the use of space. Spark plugs generally tend to be inset to minimize space and, possibly, at an awkward angle. Because of the angle that the extension member may be attached to a socket, it may not be possible to deliver the necessary torque through the extension member 10. In such instances, a secondary, external, removable wrench can be used on the perimeter 20 to deliver the necessary torque to the extension member 10. The present invention provides a gripping surface for such a second wrench.

Still referring to FIG. 1, a lip or a protrusion 22 is located where the shaft portion 16 meets the second end portion 14. The lip 22 provides an abutment 26, which helps in aligning a secondary wrench around the perimeter 20 and prevents the secondary wrench from sliding down the shaft portion 16 when using the secondary wrench. The lip 22 can also assist in locating the second end portion 14 when a user is trying to secure the secondary wrench around the second end portion 14, especially when the extension member 10 is not necessarily visible to the user. To further assist in properly aligning and attaching an external wrench, a bolster 24 is shown attached to the second end portion 14 near the abutment 26. The bolster 24 is preferably removable, which allows the size or width of the bolster 24 to be adjusted if necessary. The bolster 24 can also be used as a shock absorber or cushioning device, which can make it easier for the user to properly position an external wrench on the second end portion 14 and helps to securely hold the secondary wrench onto the second end portion 14.

FIG. 2 refers to a second embodiment 110 of an extension member according to the present invention. The second embodiment 110 is similar to that of the first embodiment 10, having a first end portion 112, and a second end portion 114, and a shaft portion or extension portion 116 located between the first end portion 112 and the second end portion 114, with the general arrangement of each of the sections being the same as that of the first embodiment 10. The shaft portion 116 also has a lip 122 that forms an abutment 126 where the second end portion 114 meets the shaft portion 116. The second embodiment 110 differs from the first extension member 10 in that the second end portion 114 comprises a pair of bolsters 124a and 124b, rather than a single bolster, as shown in the first embodiment. The bolsters 124a and 124b are spaced apart on the second end portion 114, with the possibility of more bolsters being incorporated or attached to the second end portion 114. The use of a pair of bolsters 124a and 124b further assists in properly aligning an external wrench onto the extension member 110. For example, the bolsters 124a, 124b may be spaced apart so that an external wrench will rest on the second end portion 114 between the two bolsters 124a, 124b. Also, depending on the length of the second end portion 114, the bolsters 124a, 124b (and potentially other bolsters, not shown) can provide alternate placement options for the secondary wrench for delivering torque to the extension member 110. This is a beneficial feature when using the extension member 110 in tight or awkward places or angles, such as when the extension member 110 is used in an upside-down position, or where the first end portion 112 is vertically above the second end portion 114 when in use. For example, when a user needs to attach a secondary wrench to the extension member 110 by sliding it up the shaft portion 116 onto the second end portion 114, the bolster 124b provides a solid surface for the second wrench to be positioned against for proper torque delivery.

FIG. 3 provides an alternate view of the extension member 110, with the bolsters 124a and 124b removed. A pair of grooves 144a and 144b are designed to receive the bolsters 124a and 124b, respectively. Preferably, the grooves 144a and 144b are identical in size and shape, so that the same bolster could be used in either of the grooves 144a and 144b. Thus, the extension member 110 could be arranged or rearranged as necessary, with a bolster located in either of the grooves, only one of the grooves, or in neither of the grooves. The arrangement and design allows flexibility and adjustability for the extension member 110. It is also understood that the extension member 10 (FIG. 1) preferably comprises a groove 44 that will support the bolster 26, just as the grooves 144a and 144b support the bolsters 124a and 124b.

The bolsters used in the present invention can be of any suitable design that would provide a load bearing shoulder and potentially assist in aligning an external wrench on the disclosed extension members. Bolsters according to the present invention extend outwardly from the second end portion of the socket extension, and are independent from lips or abutments, as discussed above. Furthermore, the bolster could be a soft or pliable bolster, possibly manufactured from a pliable rubber material, or a hard or rigid bolster, possibly manufactured from a hard plastic material. FIG. 4 provides various possible bolsters that could be used with the present invention, namely in grooves 44, 144a, and/or 144b. As examples, the bolster could be an O-ring 24a, a C-clip (24b, 24c), or an e-clip 24d, or another similar device. The O-ring 24a would be an example of a soft bolster, while the C-clips (24b, 24c) or the e-clip 24d would be an example of a rigid bolster. The bolsters shown in FIG. 4 are merely exemplary, and other similar bolster could be used, as well. Further different bolsters, such as the O-ring 23a and the e-clip 24d, could be used in combination upon a single extension member 110.

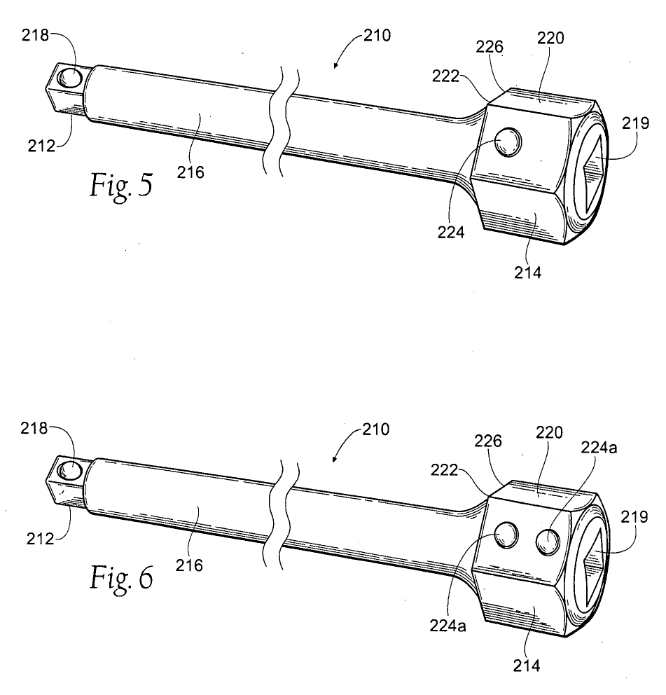

While the previous embodiments have discussed bolsters that generally surround the extension members, with the bolsters potentially being removable from the extension members, the present invention encompasses other bolster designs as well. As examples, FIGS. 5 6 provide further embodiments having alternate bolster arrangements. FIGS. 5 and 6 show a perspective view of an extension member 210 generally comprising a first end portion 212, a second end portion 214, and a shaft or extension portion 216, similar to the previous embodiments. Likewise, the first end portion 212 includes a ball retention 218 provided thereon the first end portion 212 for retaining a socket (not shown). The second end portion 214 preferably comprises a square bore 219, so that the extension member 210 can be attached to a standard socket wrench, ratchet, or other torque delivering device (not shown) to be attached to the extension member 210. The second end portion 214 has a perimeter 220, preferably hexagonal in shape, which allows a secondary device to provide additional torque to the extension member 210. Still referring to FIG. 5, a lip or a protrusion 222 provides an abutment 226, which helps in aligning a secondary wrench around the perimeter. To further assist in properly aligning and attaching an external wrench, a bolster 224 is shown attached to the second end portion 214 near the abutment 226. The bolster 224 works to align a second wrench as described with the previous embodiments. However, the bolster 224 is not removable from the extension member 210, but rather comprises a depressible member. The depressible bolster could be designed similarly to the detent 218 or possibly another retractable push pin type device. The bolster 224 will provide an abutting surface for a second wrench just as the previous embodiments had done.

Referring particularly to FIG. 6, the extension member 210 has a pair of bolsters, 224a and 224b, compared to a single bolster 224 of FIG. 5. The bolsters 224a and 224b comprise depressible members that allow for a second wrench to be situated on the second end portion 214 of the extension member 210. The pair of bolsters 224a and 224b provides an arrangement similar to the extension member 110 described and shown in FIG. 2. That is, the bolsters 224a and 224b are spaced apart on the second end portion 214 to allow for alternate placement of a second wrench and, also, allowing for a second wrench to sit between the bolsters 224a and 224b.

The present invention provides numerous advantages over previous extension sections or members. For example, the exterior surface of the second end portion would allow a person to finger tighten the extension member, which could be useful when working under a cramped area, such as under a dashboard. The shape of the second end allows for easy identification by feel or touch from other tools, and the polygonal shape prevents the extension member from rolling away from a user when set down on a surface. The present invention provides an improved extension member that will allow a user to more efficiently perform various jobs compared to prior art extension members.

The lengths of the extensions of the present disclosure can vary over a wide range whether made in metric units, English units, ASCII units, or other units. The size of the square projection intended for operation by being inserted into a socket wrench can also vary over a very wide range. The size of the hexagonal wrench portion can vary over a wide range, and when the extension is being operated by an open-end wrench, crescent wrench, closed-end wrench, or different size socket wrench with ratchet, it need not be of the same units of measurement as the square projection on the other end of the extender, or of the square bore inside of it.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. An extension member for use with a socket wrench or a second wrench, said extension member comprising:
a first end portion;
a shaft portion connected to said first end portion;
a second end portion connected to said shaft portion opposite of where said shaft portion is connected to said first end portion,
said second end portion comprising a bore for receiving said socket wrench,
said second end portion having an exterior surface shaped to matingly receive the second wrench to provide an alternate torque delivery mechanism; and
a bolster located on said second end portion of said extension member.

2. The extension member according to claim 1 wherein said bolster is removable from said extension member.

3. The extension member according to claim 2 further comprising a circumferential groove located on said second end portion of said extension member, said groove being shaped to receive said bolster.

4. The extension member according to claim 1 wherein said bolster comprises a pliable material.

5. The extension member according to claim 1 wherein said bolster comprises a rigid material.

6. The extension member according to claim 1 further comprising a lip located where said shaft portion is connected to said second end portion.

7. The extension member according to claim 1 wherein said bolster comprises a depressible detent.

8. An extension member for use with a socket wrench or a second wrench, said extension member comprising:
a first end portion;
a shaft portion connected to said first end portion;
a second end portion connected to said shaft portion opposite of where said shaft portion is connected to said first end portion,
said second end portion comprising a bore for receiving said socket wrench,
said second end portion having an exterior surface shaped to matingly receive said second wrench to provide an alternate torque delivery mechanism;
a first bolster located on said second end portion of said extension member; and
a second bolster located on said second end portion of said extension member.

9. The extension member according to claim 8 wherein at least one of said bolsters is removable from said extension member.

10. The extension member according to claim 8 further comprising a pair of circumferential grooves located on said second end portion of said extension member, said grooves being shaped to receive said bolster.

11. The extension member according to claim 8 wherein at least one of said bolsters comprises a pliable material.

12. The extension member according to claim 8 wherein at least one of said bolsters comprises a rigid material.

13. The extension member according to claim 8 further comprising a lip located where said shaft portion is connected to said second end portion.

14. The extension member according to claim 8 wherein at least one of said bolsters comprises a depressible detent.

15. An extension member for use with a socket wrench or a second wrench and a socket, said extension member comprising:
a first end portion including a detent, said first end portion being shaped for insertion into said socket;
a shaft portion connected to said first end portion;
a second end portion connected to said shaft portion opposite of where said shaft portion is connected to said first end portion,
said second end portion comprising a bore for receiving said socket wrench,
said second end portion having a hexagonal exterior surface shaped to matingly receive the second wrench to provide an alternate torque delivery mechanism;
at least one groove circumferentially surrounding said exterior surface of said second end; and
at least one bolster being removably insertable into said groove.

16. The extension member according to claim 15 wherein said bolster comprises a pliable material.

17. The extension member according to claim 15 wherein said bolster comprises a rigid material.
